(19) United States
(12) Patent Application Publication
(10) Pub. No.: US 2017/0191750 A1
(43) Pub. Date: Jul. 6, 2017

(54) SYSTEM AND METHOD FOR COMPRESSOR INTERCOOLER

(71) Applicant: General Electric Company, Schenectady, NY (US)

(72) Inventors: Ian Alexandre Araujo De Barros, West Chester, OH (US); Michael Ralph Storage, Beavercreek, OH (US); Paul Richmond, Amelia, OH (US); Paul R. Angel, Fairfield, OH (US); David Stanley, Plymouth, MA (US)

(21) Appl. No.: 15/392,914

(22) Filed: Dec. 28, 2016

Related U.S. Application Data
(60) Provisional application No. 62/274,142, filed on Dec. 31, 2015.

(51) Int. Cl. F25J 1/02; F02C 3/06; F02C 7/143; F25J 1/00

(52) U.S. Cl. CPC F25J 1/0283; F25J 1/0012; F25J 1/0022; F02C 3/06; F02C 7/143; F05D 2220/32

(57) ABSTRACT

A method includes compressing an air flow to a first pressure, transferring heat from the air flow to a liquefaction fluid via an intercooler heat exchanger, compressing the air flow to a second pressure greater than the first pressure, combusting the air flow and a fuel to generate a combustion product flow, and driving a turbine with the combustion product flow. The turbine is configured to drive machinery of a liquefaction system. The liquefaction fluid includes at least one of a pre-cooling fluid, a refrigerant, and a liquefied product of the liquefaction system.

### CROSS REFERENCE TO RELATED APPLICATIONS

This application claims priority from and the benefit of U.S. Provisional Application Ser. No. 62/274,142, entitled “SYSTEM AND METHOD FOR COMPRESSOR INTERCOOLER,” filed Dec. 31, 2015, which is hereby incorporated by reference in its entirety for all purposes.

### BACKGROUND OF THE INVENTION

The subject matter disclosed herein relates to systems and methods for an intercooler, and more specifically to an intercooler for a compressor stage of a gas turbine system.

In a gas turbine engine for example, air is pressurized in a compressor and mixed with fuel in a combustor for generating hot combustion gases which flow downstream and expand through turbine stages. A turbine shaft coupled to the turbine stages may drive multiple compressor stages. Turbine engines are utilized generally in the power industry to create energy, which is utilized for industrial use, or in communities' residential and commercial use. Intercoolers may be utilized to cool a fluid (e.g., air) between compression stages by transferring heat from the compressed fluid via a heat exchanger. However, there are various difficulties with known intercooler packages or systems. For example, in power generation industry, the intercoolers utilized are extremely large, expensive, and difficult to transport. Additionally, systems to supply a working fluid to the heat exchanger of the intercooler to cool the fluid are also large, expensive, and difficult to transport.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, a system includes a gas turbine system, an intercooler heat exchanger, and a liquefaction system. The gas turbine system includes a first compressor stage configured to compress an air flow to a first pressure, a second compressor stage configured to compress the air flow to a second pressure greater than the first pressure, and a turbine disposed along an axis of the gas turbine system. The intercooler heat exchanger is disposed between the first compressor stage and the second compressor stage. The intercooler heat exchanger includes a body having a plurality of channels configured to receive a cooling fluid and a plurality of fins extending from the body. The air flow is configured to flow over the plurality of fins, and the intercooler heat exchanger is configured to transfer heat from the air flow to the cooling fluid. The liquefaction system is indirectly coupled to the intercooler heat exchanger. The liquefaction system includes a liquefaction fluid configured to receive heat from the cooling fluid.

In a second embodiment, a system includes a gas turbine system, an intercooler heat exchanger, and a liquefaction system. The gas turbine system includes a first compressor stage configured to compress an air flow to a first pressure, a second compressor stage configured to compress the air flow to a second pressure greater than the first pressure, and a turbine disposed along an axis of the gas turbine system. The intercooler heat exchanger is disposed between the first compressor stage and the second compressor stage. The intercooler heat exchanger includes a body having a plurality of channels configured to receive a liquefaction fluid and a plurality of fins extending from the body. The air flow is configured to flow over the plurality of fins, and the intercooler heat exchanger is configured to transfer heat from the air flow to the liquefaction fluid. The liquefaction system is directly coupled to the intercooler heat exchanger. The liquefaction fluid of the liquefaction system includes a pre-cooling fluid, a refrigerant, or a liquefied product of the liquefaction system, or any combination thereof.

In a third embodiment, a method includes compressing an air flow to a first pressure, transferring heat from the air flow to a liquefaction fluid via an intercooler heat exchanger, compressing the air flow to a second pressure greater than the first pressure, combusting the air flow and a fuel to generate a combustion product flow, and driving a turbine with the combustion product flow. The turbine is configured to drive machinery of a liquefaction system. The liquefaction fluid includes at least one of a pre-cooling fluid, a refrigerant, and a liquefied product of the liquefaction system.

A volumetric duct conforming fin heat exchanger for an intercooler is provided. The intercooler has a heat exchanger formed of a plurality of segments. The plurality of segments may be arranged to conform to a duct through which a flowpath passes. The intercooler includes a body having a plurality of openings for a fluid to path through. On the outer surface of the body a plurality of fins are skived into the body to engaging the flowpath. According to other embodiments, the heat exchanger may be disposed in alternate devices such as filter houses to control temperature of inlet air as well as control moisture.

According to some embodiments, a plurality of modules may be formed from the segments to ease assembly of the heat exchanger and to provide easier access to remove portions during maintenance or improve access internally of the intercooler. A bifurcation is provided in some embodiments to aerodynamically improve areas of connections between modules. Additionally, the bifurcation will accommodate thermal expansion in various dimensions between modules.

According to other embodiments, a water extraction device is provided. The water extraction device may be disposed within a flowpath, for non-limiting example a flowpath within an intercooler. The water extraction device may have one or more stages to control water content in the air flowpath by containing water droplets which momentum carries linearly through turns in the airflow path.

All of the above outlined features are to be understood as exemplary only and many more features and objectives of the embodiments may be gleaned from the disclosure herein. Therefore, no limiting interpretation of this summary is to be understood without further reading of the entire specification, claims, and drawings included herewith.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is an isometric view of an in-line heat exchanger;

FIG. 2 is an block diagram of a liquefaction system and a power plant with an inline heat exchanger intercooler;

FIG. 3 is an isometric layout of an embodiment of the power plant of FIG. 2 with an alternative off engine configuration for the heat exchanger intercooler;

FIG. 4 is an isometric view of a heat exchanger intercooler.

FIG. 5 is an isometric view of a segment of the heat exchanger.

FIG. 6 is a side section view of the heat exchanger intercooler.

FIG. 7 is a side section view of an alternative heat exchanger intercooler.

FIG. 8 is a side section view of a further alternative heat exchanger intercooler.

FIG. 9 is an isometric view of the heat exchanger showing a modular design.

FIG. 10 is an isometric view of an alternate heat exchanger showing an alternate modular design.

FIG. 11 is a isometric view of a bifurcation of the heat exchanger intercooler which allows for thermal expansion and contraction.

FIG. 12 is a side section view of the intercooler with one embodiment of a water extraction device;

FIG. 13 is a detail section view of the water extraction device of FIG. 11; and

FIG. 14 is a side section view of an exemplary intercooler with an alternate water extraction embodiment.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

Gas turbine systems may be used to drive various systems and processes. For example, gas turbine systems may be used to drive industrial systems, such as liquefaction systems. Liquefaction systems cool one or more product gases (e.g., natural gas, methane, propane, nitrogen) for storage and/or transport. As may be appreciated, liquefaction systems may utilize one or more compression stages and one or more expansion stages. In some embodiments, liquefaction systems may utilize one or more liquefaction fluids (e.g., propane, refrigerant, liquid nitrogen, or any combination thereof) to cool or subcool the one or more product gases. The gas turbine system may drive one or more of the compression stages, and the gas turbine system may drive pumps to direct fluids (e.g., product gas, liquefied product, liquefaction fluid) through the liquefaction system.

The liquefaction fluids utilized in or processed by the liquefaction system may be at temperatures cooler than the ambient temperature. For example, liquefied natural gas (LNG) may be cooled to approximately −162° C. (−260° F.) at atmospheric pressure for storage or transport. Additionally, refrigerants or other liquefaction fluids of the liquefaction system may be at still lower temperatures in some embodiments. For example, liquid nitrogen, which boils at approximately −195° C. (−320° F.), may be utilized in some liquefaction systems. Furthermore, working fluids of a liquefaction system that absorb heat from the liquefied product may generally be cooler than the gas compressed by a low pressure compressor stage of the gas turbine system.

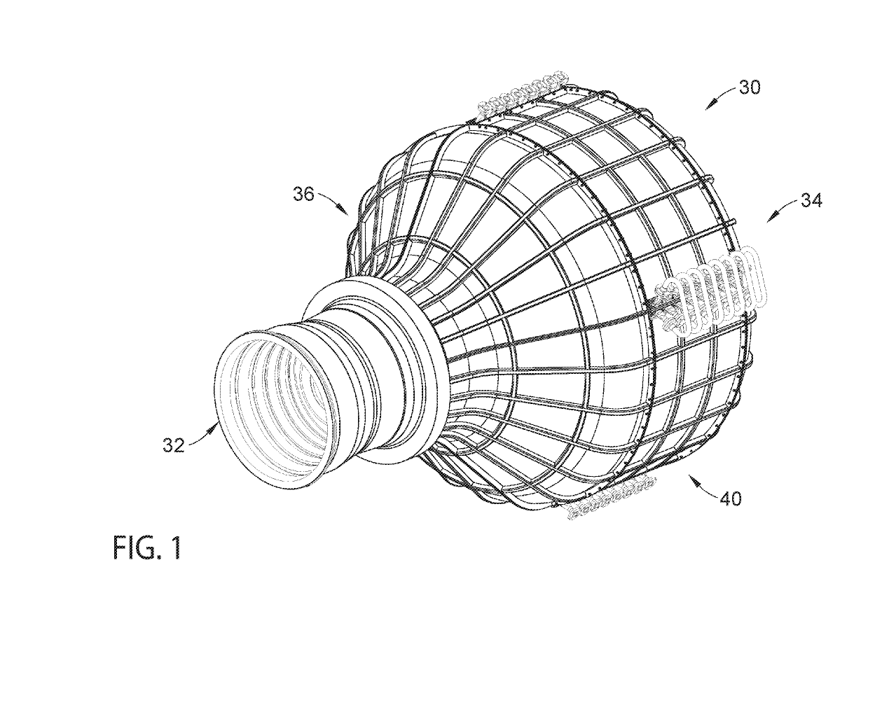

As discussed in detail below, one or more liquefaction fluids (e.g., product gas, liquefied product, refrigerant) may be utilized directly or indirectly with an intercooler to cool a compressed gas between compression stages of the gas turbine system. Various embodiments of the intercooler are discussed below in FIGS. 1-14. In some embodiments, one or more of the liquefaction fluids may be used directly with the intercooler to reduce or eliminate the footprint of a working fluid system that transfers heat from the compressed gas to the environment. Additionally, or in the alternative, one or more of the liquefaction fluids may be used indirectly with the intercooler, such as to cool the working fluid of the working fluid system that directly interfaces with the intercooler. Indirect use of one or more liquefaction fluids with the intercooler may reduce the footprint of the working fluid system relative to a gas turbine system that does not utilize liquefaction fluids. Furthermore, the integration of a liquefaction system to utilize one or more liquefaction fluids with an inline intercooler may further reduce the footprint of the gas turbine system and its associated equipment relative to a gas turbine system without an intercooler or relative to a gas turbine system with an intercooler off line from a turbine axis of the gas turbine system.

Referring to FIGS. 1-14, various embodiments of a gas turbine engine are depicted having a duct conforming fin heat exchanger intercooler. The intercooler allows for in line, or off-engine, installation with the turbine engine and has features which reduces costs of manufacturing, installation and costs associated with installation, such as property costs and shipping related costs. Other uses are well within the scope of this disclosure.

The terms fore and aft are used with respect to the engine axis and generally mean toward the front of the turbine engine or the rear of the turbine engine in the direction of the engine axis, respectively. The term radially is used generally to indicate a direction perpendicular to an engine axis.

Referring initially to FIG. 1, an isometric view of a volumetric duct conforming fin heat exchanger intercooler 30 is depicted. The intercooler 30 is utilized in a power plant for power generation or alternatively the structure may be configured for use in aviation or other areas utilizing gas turbine engines. The intercooler 30 includes an inlet end 32 and an outlet end 34 extending between the inlet and outlet is a housing 36 wherein a heat exchanger 40 is disposed. The intercooler 30 is utilized to cool air in compression stages before engaging the turbine structures utilized in power generation for other processes wherein a gas turbine engine is utilized.

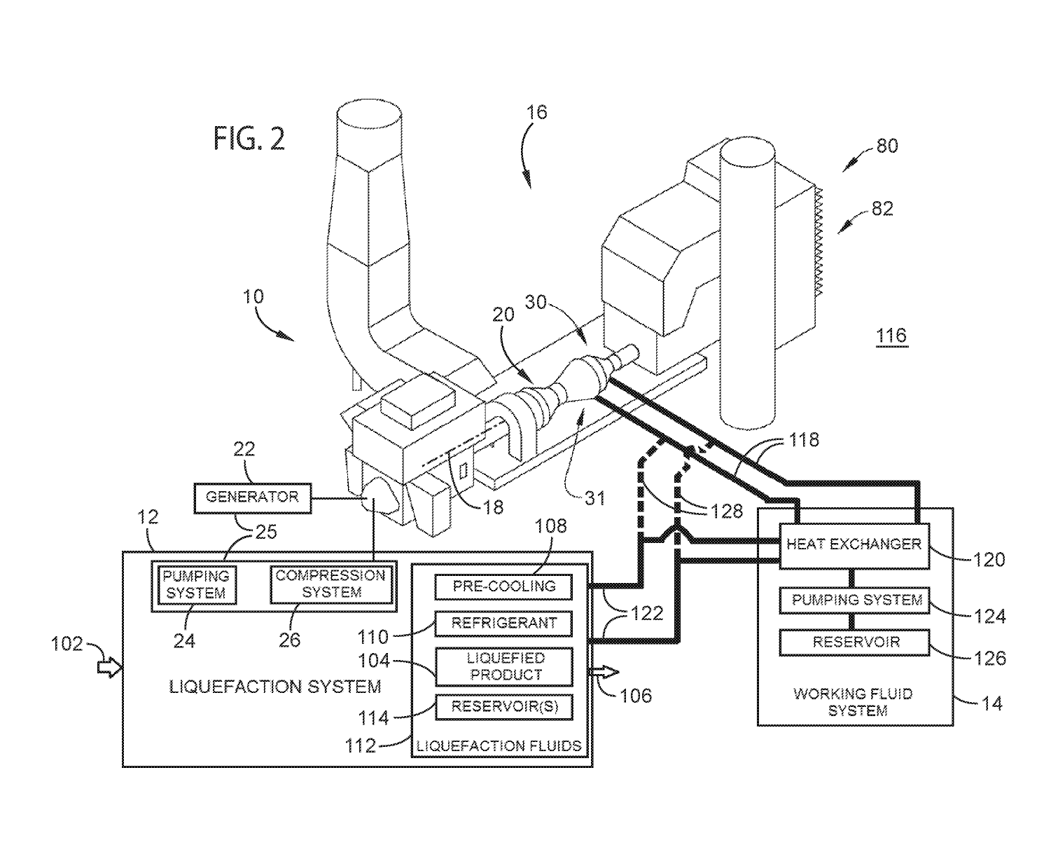

Referring now to FIG. 2, an isometric layout is shown of a power generation plant 10 with block diagrams of a liquefaction system 12 and a working fluid system 14 are shown. The power generation system 10 has a gas turbine engine 16 wherein a heat exchange intercooler 30 may be utilized. In the exemplary configuration, the embodiment provides that the intercooler 30 is disposed in line with the turbine shaft axis 18 for power generation. A turbine 20 of the gas turbine engine 16 may drive one or more loads via a turbine shaft. For example, the turbine engine 16 may drive machinery 25 including, but not limited to, a generator 22, a pumping system 24 of the liquefaction system 12, a compression system 26 of the liquefaction system 12, or any combination thereof. In some embodiments, the turbine 22 may be configured to mechanically drive a centrifugal compressor train of the compression system 26 that compresses a liquefaction fluid 112. The heat exchanger intercooler 30 is positioned in line with the axis 18 of the compressor and turbine structure of the exemplary power plant depicted. The advantage of such configuration, as previously noted, is that the airflow being cooled may be done so inline 31 (i.e., aligned with the turbine shaft) and does not have to be moved off-alignment of the turbine and compressor system. This reduces the tremendous cost associated with the duct typically required for this task. Additionally, the intercooler 30 has a smaller footprint than existing intercooler systems and therefore less plant property is needed to position the intercooler 30. Moreover, supporting equipment (e.g., variable bleed valve system) of the intercooler 30 in the inline configuration 31 may be positioned inline with the intercooler 30 rather than offline, further reducing the footprint of the power generation system 10.

The liquefaction system 12 receives a gaseous material 102 and produces a liquefied product 104 from the gaseous material 102. In some embodiments, the liquefaction system 12 is an air separation unit configured to produce a liquefied product output 106 of nitrogen, oxygen, argon, neon, krypton, or xenon, or any combination thereof. In some embodiments, the liquefaction system 12 is a liquefied natural gas (LNG) system configured to produce a liquefied product output 106 of liquefied natural gas from a gaseous material 102 that is substantially (e.g., greater than 90%) gaseous natural gas. As may be appreciated, LNG systems may use one or more of various processes to produce the liquefied product output 106. Some of the processes that may be utilized may include, but are not limited, to AP-C3MR™, Cascade, AP-X®, DMR, SMR, MFC®, PRICO®, and AP-N™, or any combination thereof. In some embodiments, the liquefaction system 12 utilizes a pre-cooling fluid 108 (e.g., water, propane, ethylene glycol solution) to pre-cool the gaseous material 102 prior to compression or other cooling with a refrigerant 110 (e.g., methane, ethane, ethylene, propane, butane, isopentane, nitrogen, argon, krypton, xenon, carbon dioxide, a hydrofluorocarbon (HFC), or any combination thereof). In some embodiments, the pre-cooling fluid 108 and/or the refrigerant 110 may be a mixed refrigerant, which may boil over a range of temperatures based at least in part on the respective boiling points of the component materials of the mixed refrigerant. As utilized herein, the term liquefaction fluid 112 may refer to a pre-cooling fluid 108, a refrigerant 110 (e.g., single refrigerant, mixed refrigerant), a liquefied product 104, or any combination thereof.

The one or more liquefaction fluids 112 of the liquefaction system 12 may be directed through one or more heat exchangers of the liquefaction system 12 by the pumping system 25. In some embodiments, one or more of the liquefaction fluids 112 may be drawn from a reservoir 114 by the pumping system 25. The one or more reservoirs 114 may facilitate thermal expansion and contraction of the respective fluid (e.g., pre-cooling fluid 108, refrigerant 110, liquefied product 104) within the liquefaction system 12, facilitate addition of the respective fluid (e.g., pre-cooling fluid 108, refrigerant 110) from the liquefaction system, facilitate removal of the respective fluid (e.g., liquefied product 104), or any combination thereof. The pre-cooling fluid 108 and the refrigerant 110 may be directed through respective closed loop circuits that include the respective reservoirs 114. The gaseous material 102 that is cooled to form the liquefied product 104 may be directed through an open loop of the liquefaction system 12, and a respective reservoir 114 may store the liquefied product 104 for later transport as the product output 106.

In some embodiments, the working fluid system 14 of the power generation plant 10 is coupled to the intercooler 30 to facilitate heat transfer to an environment 116 of the power generation plant 10 from a compressed gas after one or more first compression stages of the gas turbine system 16. As discussed in detail below, the intercooler 30 is configured to transfer heat from the compressed air to a fluid routed through channels 54 of the intercooler 30. The working fluid system 14 may supply a working fluid (e.g., oil, water, ethylene glycol solution) to the channels 54 of the intercooler 30 via conduits 118. In some embodiments, a heat exchanger 120 of the working fluid system 14 may transfer heat from the working fluid to a liquefaction fluid 112, such that some of the heat from the compressed air is transferred via the working fluid to the liquefaction fluid 112 of the liquefaction system 12. That is, heat is transferred from the compressed air to the environment 116 via the liquefaction system 12. The liquefaction fluid 112 may be coupled to the working fluid system 14 via liquefaction fluid conduits 122. Accordingly, the liquefaction fluid 112 is configured to indirectly cool the compressed air of the gas turbine system 16 that flows through the intercooler 30.

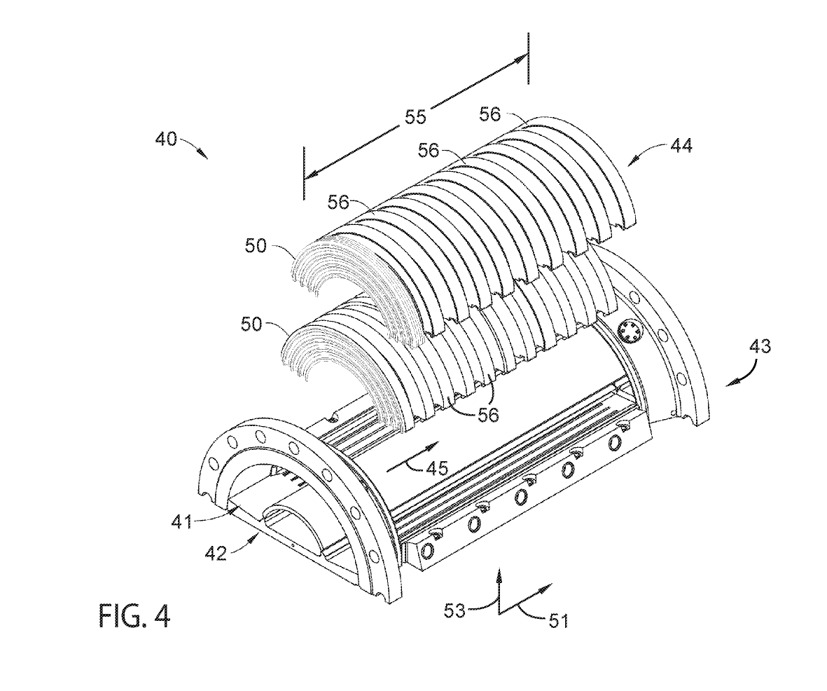

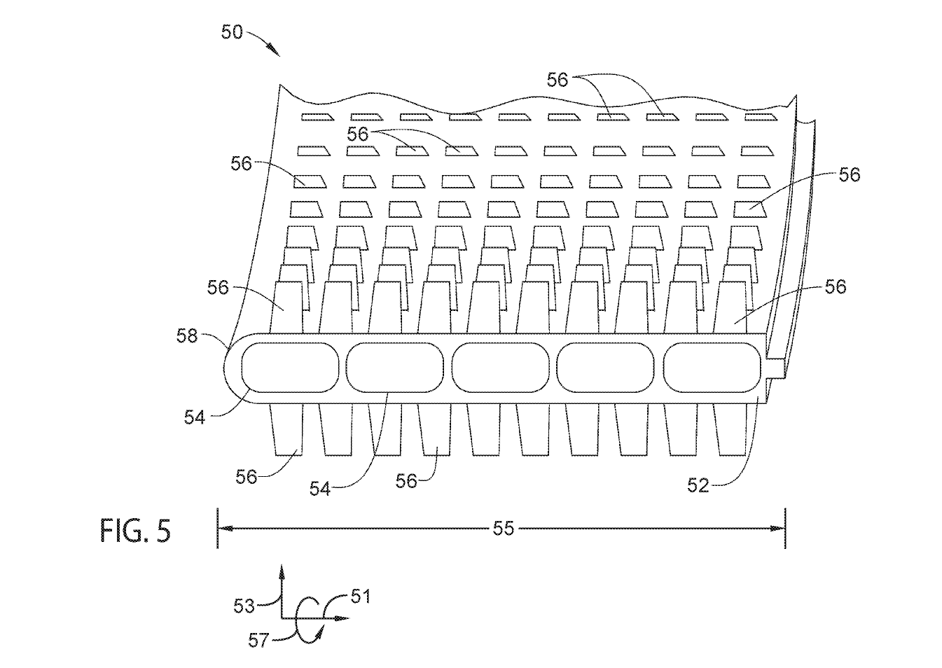

As may be appreciated, the heat exchanger 120 of the working fluid system 14 may include, but is not limited to a shell and tube heat exchanger, a plate heat exchanger, a plate and shell heat exchanger, or any combination thereof. Additionally, or in the alternative, the heat exchanger 120 may be an embodiment of a duct conforming fin heat exchanger, similar to the embodiment illustrated in FIGS. 4 and 5 discussed below. A pumping system 124 may direct the working fluid from a reservoir 126 to the heat exchanger 120 and the intercooler 30. In some embodiments, the pumping system 124 may be a thermal siphon system that uses a two phase flow without a pump rather than a single phase flow with a pump. Due to the low temperature (e.g., approximately −195 to 10° C., −162 to 0° C., −155 to −50° C.) of the liquefaction fluids 112 relative to the temperature of the environment 116, the use of one or more liquefaction fluids 112 to cool the working fluid may reduce the footprint of the working fluid system 14. That is, the use of one of the liquefaction fluids 112 may enable use of a smaller heat exchanger 120 to cool the working fluid than if the working fluid system 14 rejected the heat directly to the environment 116.

In some embodiments, one or more of the liquefaction fluids 112 may be directly coupled to the intercooler 30 as shown by the dashed lines 128. Accordingly, the one or more liquefaction fluids 112 may be directed through the channels 54 of the intercooler 30 to extract heat from the compressed air in place of or in addition to the working fluid of the working fluid system 14. This integration of the liquefaction fluid 112 with the intercooler 30 may enable the working fluid system 14 to be eliminated, thereby reducing the footprint of the power generation plant 10. As may be appreciated, elimination of the working fluid system 14 may reduce the weight and cost of the power generation plant 10. Weight and footprint reductions may be particularly beneficial for sea-based applications of the power generation plant 10.

The use of the liquefaction fluid 112 directly or indirectly with the intercooler 30 may increase a thermal load on the liquefaction system 12 due to the transfer of heat from the compressed air to the liquefaction fluid 112; however, the reduced cost, complexity, and footprint resulting from the reduction or elimination of the working fluid system 14 may be determined to be more beneficial for some power generation plants 10 with liquefaction systems 12. In some embodiments, the liquefaction fluid 112 may be a byproduct of the liquefaction system 12, such that the utilization of the liquefaction fluid does not increase the thermal load on the liquefaction system 12. For example, a portion of the liquefied product 104 (e.g., liquefied natural gas) may be used both for cooling the compressed air via the intercooler, and for fuel with the gas turbine engine 16 after the fuel is warmed.

The liquefaction fluids 112 utilized directly or indirectly with the intercooler 30 via the liquefaction fluid conduits 122 may be drawn from and returned to various points of the liquefaction system 12. As may be appreciated, the temperature of the liquefaction fluid 112 may vary as the liquefaction fluid 112 is directed through a vapor-compression loop within the liquefaction system 12. Accordingly, the pre-cooling fluid 108 or refrigerant 110 may be warmer at an outlet of a heat exchanger of the liquefaction system 12 than at an inlet of the heat exchanger. Moreover, the liquefaction fluid 112 may be warmer prior to an expansion of the respective liquefaction fluid 112 than after expansion. In some embodiments, the intercooler 30 is configured to reduce the temperature of the compressed air from approximately 200° C. to approximately 35° C. The extraction point and temperature of the liquefaction fluid 112 utilized may be selected based at least in part on the effectiveness of the intercooler 30, the flow rate of the liquefaction fluid 112 through the liquefaction fluid conduits 122, material properties of the intercooler 30, among other parameters.

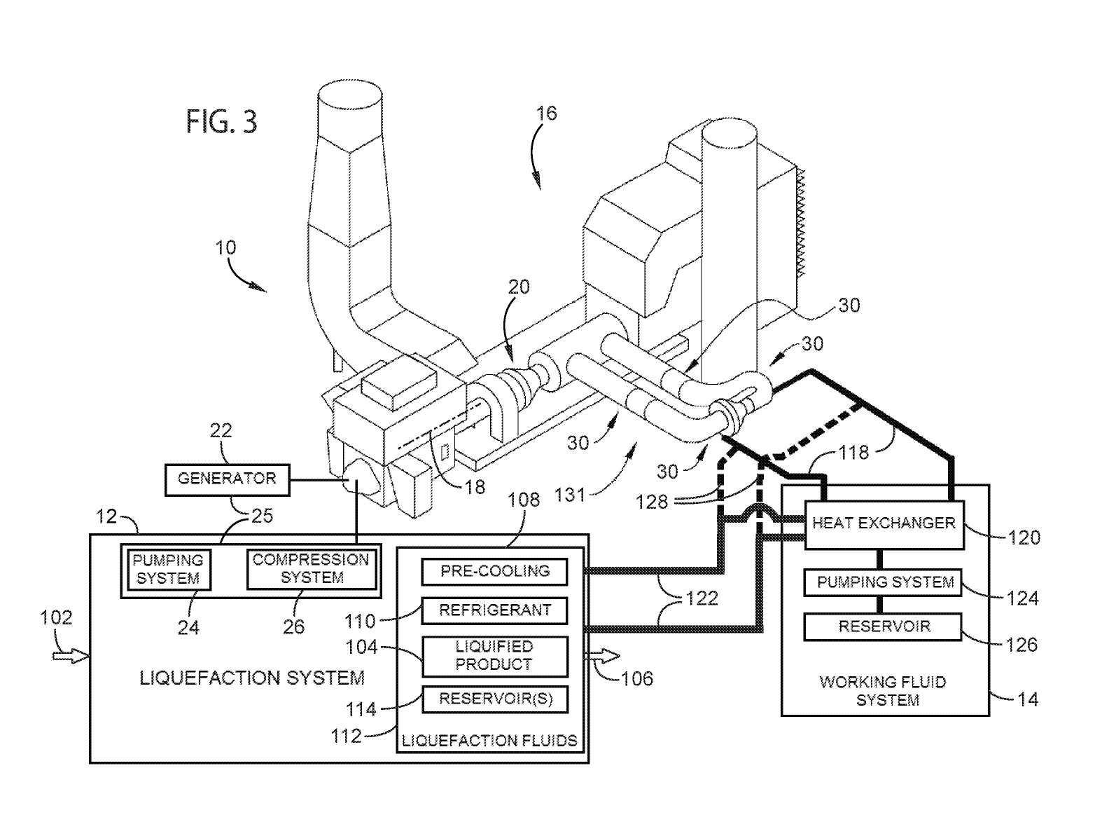

Referring to FIG. 3, an alternative embodiment of the power generation plant 10 is depicted wherein the intercooler 30 may be positioned in various locations. Although three intercoolers 30 are depicted, these may be used individually with a system in general, and therefore FIG. 3 depicts various locations that the intercoolers 30 may be disposed. The figure should not be construed to require three separate intercoolers utilized. In the embodiment of FIG. 3, the intercoolers 30 are depicted in an offline configuration 131 where the intercooler is off line or off axis from the compressor and turbine axis 18 of the power plant 10. The structure may be disposed in either of the two ducts traditionally utilized with known intercooler designs or may be positioned in replacement of known intercooler designs at ends of the ducts shown. The ducts may be circular or other geometrically shaped cross-sections and further may be straight ducts or curved. Thus the heat exchanger is duct conforming in both the inline configuration 31 of FIG. 2 and the off axis configuration of FIG. 3.

Referring now to FIG. 4, an isometric view of the exemplary heat exchanger 40 of the intercooler 30 is depicted. The heat exchanger 40 is disposed within the intercooler 30 as previously described and an airflow passes over an outside of the heat exchanger 40 to cool the airflow or remove heat from a fluid flow within the heat exchanger 40. The heat exchanger 40 has an inlet end or face 41, an outlet end or face 43, and a passageway 45 therebetween. The heat exchanger 40 is formed of a plurality of segments 50 which extend between an axially forward end 42 and an axially aft end 44. In addition to extending the segments 50 in an axial direction 51, the segments 50 are stacked on top of one another in a radial direction 53 to increase the radial dimension of the heat exchanger 40. Thus, the heat exchanger 40 is formed of annular ring sections or segments which span a flow duct and allowing penetration flow area for heat exchange. The segments 50 laid in the radial direction provide for a cylindrical mesh which allows heat transfer as air flows through the heat exchanger 40. As discussed below, each segment 50 has a plurality of fins 56. While FIG. 4 illustrates the fins 56 of each segment 50 as semicircular ridges extending circumferentially, it may be appreciated that each semicircular ridge of FIG. 4 is a simplified illustration of a plurality of fins 56 as illustrated separately in FIG. 5. The heat exchanger 40 of the embodiment shown is generally cylindrical however other shapes may be utilized to conform the heat exchanger 40 to a duct wherein the exchanger 40 is positioned. For example, the structure may be tapered in the radial direction 53 across an axial length 55. Additionally, other geometric shapes than the circular cross section depicted may be also utilized. Additionally, the heat exchanger 40 may be curved to match a curved axis of a curved duct, as previously noted.

Referring now to FIG. 5, one segment 50 of the heat exchanger 40 is depicted. The segment 50 includes a body 52 which extends circumferentially and along the axial length 55. Across the axial length 55 are a plurality of flow paths or channels 54, which extend in a circumferential direction 57, allowing flow of for example, oil needing cooling or alternatively, a cooling fluid utilized to reduce air temperature moving through the heat exchanger 40. As discussed above, the channels 54 may allow the flow of the working fluid (e.g., oil, water, ethylene glycol solution) of the working fluid system 14 or a liquefaction fluid 112 of the liquefaction system 12. In some embodiments, the channels 54 are fluidly coupled to one another and oriented in the axial direction such that the working fluid or the liquefaction fluid 112 generally flows parallel to or counter to the flow of the air through the heat exchanger 40. That is, the channels 54 may be one or more spiraled passages extending in both the circumferential direction 57 and the axial direction 51. In some embodiments of the heat exchanger 40 with radial layers of sections 50, the channels 54 of a first layer may receive cooling fluids (e.g., working fluid, liquefaction fluid) with a first composition or first temperature, and the channels 54 of a second layer may receive cooling fluids (e.g., working fluid, liquefaction fluid) with a second composition or second temperature, where the first composition may be different than the second composition, and the first temperature may be different than the second temperature.

The segment 50 also includes a plurality of fins 56 extending in the radial direction 53. The fins 56 are formed in a skiving process from a single piece of material which also defines the body 52. By skiving the fins 56, the process of brazing multiple fins to the body 52 is eliminated, and therefore the costs for producing the segments 50 may be reduced. The body structure 52 is generally extruded and in a subsequent process the skiving step carves the fins 56 from the single piece of metal. The fins 56 may be carved in one or more directions, for example as shown in the axial direction 53 and circumferential direction 57. Alternatively, the fins 56 may extend at some angle similar to a helical fin structure as well.

Additionally, the fins 56 are shown extending radially from the body so as to extend outwardly therefrom the body 52. However, according to other embodiments fins 56 may be carved so as to extend either radially inward or both radially inward and outward.

As described earlier, the body 52 includes a plurality of flow paths or channels 54 for a fluid to be cooled or a fluid to cool the airflow. The axially forwardmost flow channel 54 alternatively according to one embodiment may be a blank. That is to say, the forwardmost flow path may not receive any fluid flow therein so as to preclude fluid leakage from foreign objects entering the heat exchanger 40, also referred to as foreign object damage. Additionally, at this forward end of the segment 50, a leading edge 58 of the body 52 is curved to improve aerodynamics of the segment 50. Likewise, the leading edge may have an increased material thickness to decrease damage from foreign object in the air flow path encountering the heat exchanger 40. The trailing edge may alternatively be curved. Various other shapes or arrangements may be utilized for a leading edge to improve overall aerodynamics of the entire assembly of the heat exchanger 40.

Referring now to FIGS. 6-8, the various figures depict alternate profiles that the heat exchanger 40 may have within the intercooler 30. Referring first to FIG. 6, a heat exchanger 40 is depicted with a rectangular profile when viewed in side section. This rectangular shape is created in part by the face shape at the forward end 42 of the exchanger 40, as well as the aft end of the exchanger. The forward end 42 may be varied as described in alternate embodiments.

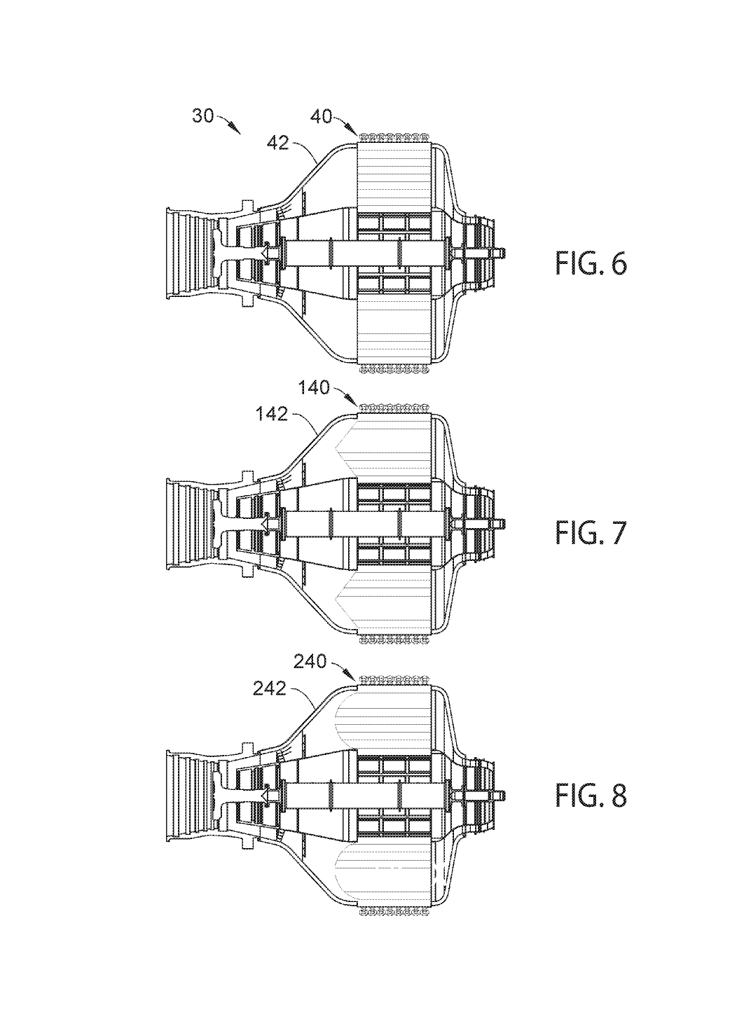

Referring now to FIG. 7, an alternative geometric shape is depicted. According to this embodiment, a forward end 142 of a heat exchanger 140 utilizes tapered forward face to form a polygon shaped profile. Such shape may be desirable to improve aerodynamics or alternatively limit damage from object within the flow stream. According to a further embodiment, and with reference to FIG. 8, the heat exchanger 240 may include a leading profile 242 which is torus shaped. Again, this may be done for various reasons included but not limited to aerodynamics and limiting damage caused by material in the flow path.

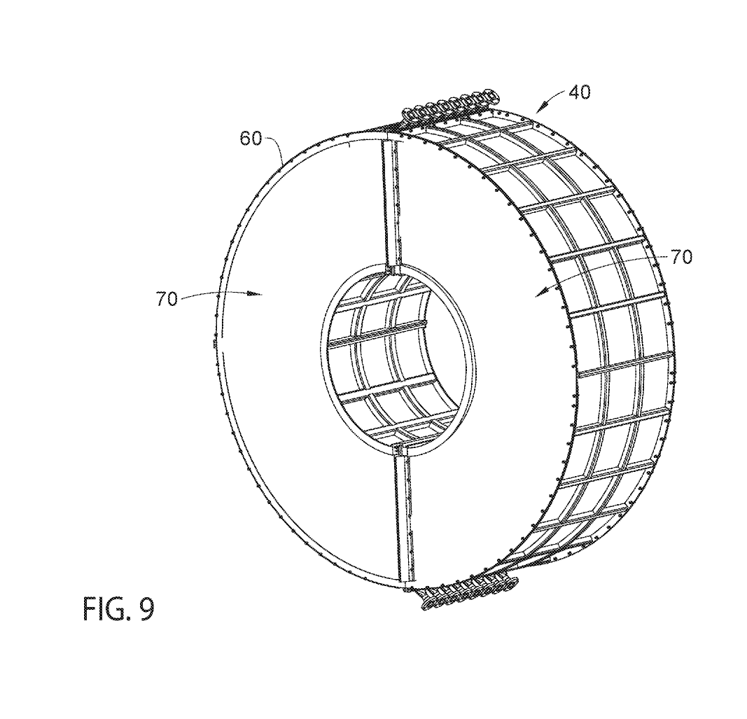

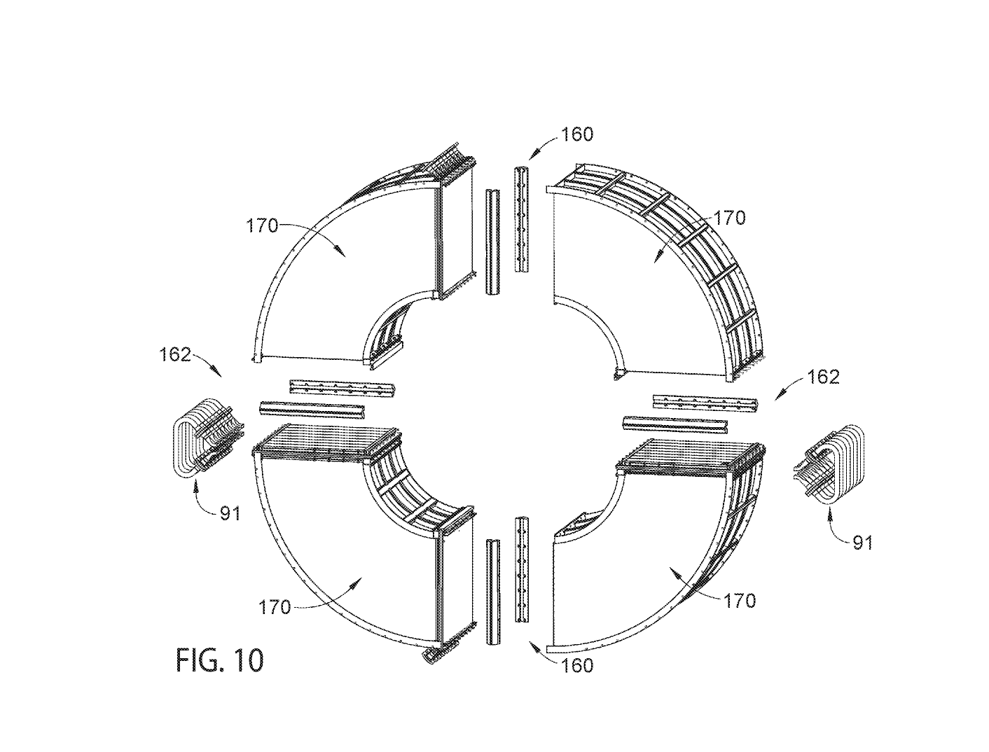

Referring now to FIG. 9, the heat exchanger 40 may be formed in various modular designs or shapes. In the embodiment depicted, a structure is shown with a split 60 extending radially through the exemplary heat exchanger 40 to allow the structure to be constructed in two modules 70 and connected together. However, alternate embodiments may be formed wherein multiple cut lines are utilized to form more modular shape without limiting function of the structure. For example, according to the embodiment shown in FIG. 10, the heat exchanger has four modular sections 170 defined by two linear splits 160-162 to define the quadrants. However, these embodiments may be formed in various shapes with various axial and/or angular lengths at the radially outer surface of the modules. As may be appreciated, each of the modules 70, 170 of FIGS. 9-11 may have the plurality of fins 56 as illustrated in FIG. 5 and described above.

Referring again to FIG. 2, the plant layout is shown in isometric view with a filter house 80 at the forward end of the process. The filter house takes in air through an inlet 82 and filters out some material for air is directed to a low pressure compressor and subsequently to the intercooler 30. The structure of the heat exchanger may alternatively be used in the filter house 80 according to an alternate embodiment. In this embodiment, the body 52 is not curved circumferentially but may instead be flat or may be formed to provide various geometric shapes. The body may be supplied with a fluid (e.g., chilled water, working fluid of the working fluid system 14, liquefaction fluid 112 of the liquefaction system 12) to cool the air if the power plant is in a high temperature and high humidity environment. Cooling the air may facilitate water extraction (e.g., via condensation) from the air directed through the filter house 80. According to an alternate embodiment a warming fluid may be utilized if the power plant is located in an extremely low temperature environment and the temperature of the incoming air needs to be raised. Thus, the heat exchanger may act as a preheater or a precooling portion within the filter house 80 at some position prior to the low pressure compressor step of power generation. Optionally, water may be removed from the air entering the filter by natural condensation due to cooling of the air or further optional methods described further herein. According to some embodiments of the instant disclosure, the body structure of the segments may be used to provide heating fluid for preheating of air coming into the inlet 82. Other segments may be utilized for cooling fluid as previously described if the power plant is located in an extremely high temperature or high humidity environment. According to other embodiments, the totality of segments may be used for either heating or cooling. The heating fluid or the cooling fluid through the channels 54 of the heat exchanger utilized in the filter house 80 may include, but is not limited to a working fluid of the working fluid system 14, or a liquefaction fluid 112 of the liquefaction system 12, as discussed above with FIG. 2.

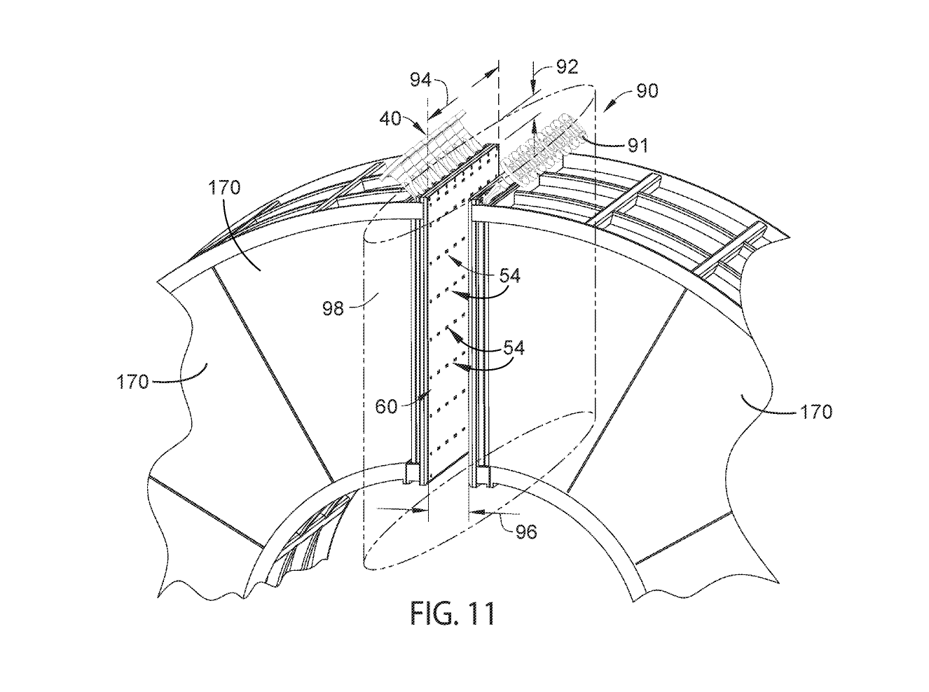

Referring now to FIG. 11, an isometric view of one exemplary heat exchanger 40 is shown. A bifurcation 90, shown in broken line for clarity, is disposed at each of the splits 60 which define the modular portions of the heat exchanger 40. The bifurcations 90 inhibit airflow from passing over the structures joining the modules of the heat exchanger 40. The bifurcations 90 therefore inhibit pressure losses which would otherwise occur. The bifurcations 90 also have a second function in that the bifurcations 90 allow for thermal growth of the heat changer 40. From start up to normal operation, the heat exchanger 40 will grow radially 92 and axially 94. Additionally, the modules will increase in size circumferentially 96 so that the splits 60 or 160, 162 will increase in dimension. This is due in part to a radial and axial temperature distribution through the heat exchanger 40. The bifurcation 90 compensates for, or accommodates, the thermal expansion of the heat exchanger 40 during operation. The bifurcation 90 depicted has an aerodynamic profile 98 to aid air flow movement structures joining the modules. Additionally, the bifurcation 90 will accept connections from fluid sources and/or house piping for such fluid wherein the fluid will pass through the heat exchanger 40.

As depicted in FIG. 11, the view shows how fluid (e.g., working fluid, liquefaction fluid 112) moves into the split 60 and then may move circumferentially through ducts or channels 54 of the segments 50 defining the modules. The fluid may make a single pass from one split to another. In some embodiments, the fluid may make multiple (e.g., 2, 4, 8, or more) passes through the heat exchanger 40. The fluid may also move across a split 60 by way of jumper tubing 91. In a further alternative, the fluid may exit after an incomplete revolution, or may complete at least one or more full or partial revolutions about the heat exchanger before exiting through at one of the splits. One skilled in the art will understand that the arcuate distance traveled by fluid through the heat exchanger 40 may vary based on the radius of the heat exchanger and the amount of cooling needed either for the fluid or for the air passing through the heat exchanger 40.

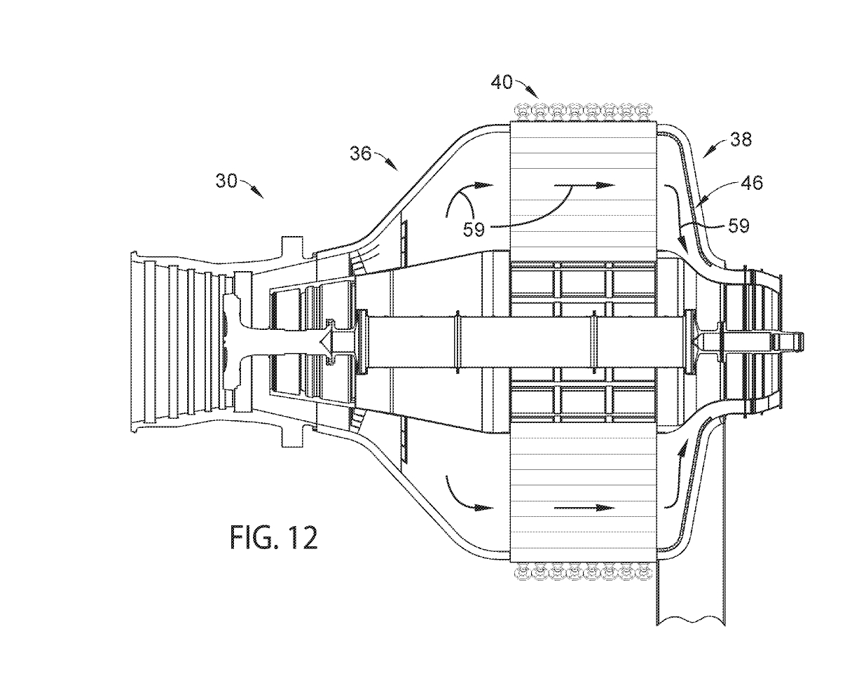

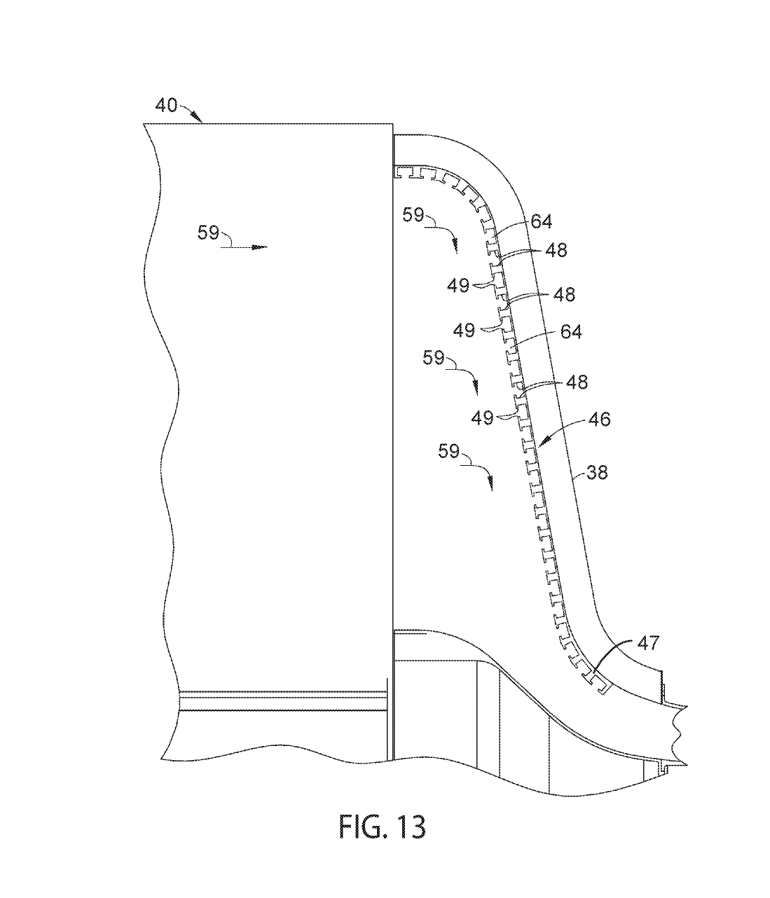

Referring now to FIGS. 12 and 13, side section views of the intercooler 30 are depicted including the heat exchanger 40. The flow path 59 passing through the heat exchanger 40 engages a rear or aft wall 38 of the housing 36. The aft wall 38 has an interior surface including a water extraction apparatus 46 (FIG. 12), which extends circumferentially about the axis of the intercooler 30. The water extraction apparatus 46 includes a baffle 47 with a plurality of risers 48 extending generally perpendicular to the baffle 47. The baffle 47 may be flat or may be curvilinear to match the contour of the rear wall 38. The risers 48 may be exposed at some angle other than 90 degrees to the baffle 47 but in general create a plurality of channels 64. Heads 49 are located at ends of the risers 48 opposite the baffle 47 and reduce the opening size of the channels 64. This aids in retaining water that is captured within the channels 64. An absorbant material may be positioned on inner surface of the channels 64 and/or along the outer surface of the heads 49 to retain water droplets and prevent them from being re-entrained in the airflow 59 passing adjacent the water extraction apparatus 46. The instant embodiment utilizes heads 49 that are generally parallel to the baffle 47 such that the head 49 and the riser 48 create T-shaped cross-section. However, alternative shapes may be utilized such as, for example, a Y-shaped cross section or other designs. In any event, the channel 64 is wider than a neck 66 created between ends of the heads 49. The water extraction apparatus 46 is located along the rear surface 38 of the intercooler 30 as depicted in FIG. 12.

In operation, air flow 59 moves through the intercooler 30 and passes through the heat exchanger 40. After moving through the heat exchanger 40, the air flow 59 turns rapidly and engages the water extraction apparatus 46 located along the rear wall 38 of housing 36. The air flow 59 changes direction rapidly due to change in the profile and shape of the housing 36. However, momentum of the water particles carries along the previously defined path so that the water particles are carried into the water extraction apparatus 46 and collected in the channels 64. The water drains through these channels 64 to a desired extraction point and may be collected or dumped as appropriate from the intercooler 30. The collection or extraction point may be at the bottom of the water extraction apparatus 46 or the intercooler 30 so that gravity moves the collected water out of the system. The water extraction apparatus 46 may have a moisture capture material, such as a mesh fabric, plastic mesh, or sponge material configured to reduce or eliminate re-entrainment of collected water.

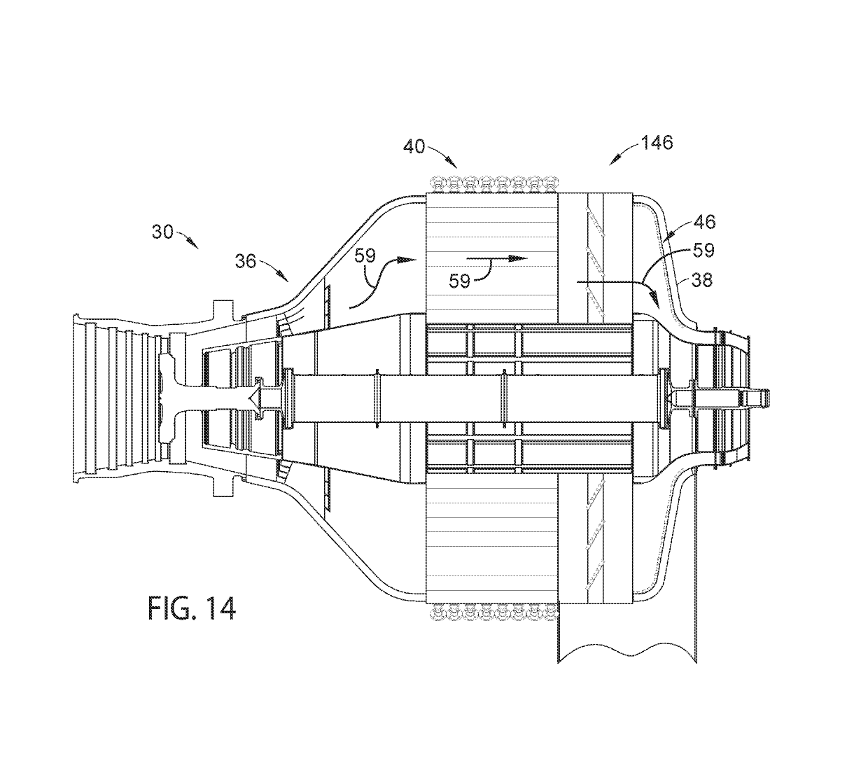

Referring to FIG. 14, an alternate embodiment is utilized wherein the water extraction apparatus 146 is located between the heat exchanger 40 and the aft wall 38 of the housing 36. The water extraction apparatus 146 sees air flow 59 from the heat exchanger and engages the air flow 59 capturing the water particles out of the air flow 59 as previously described as the air flow 59 is forced to turn. Channels defined by the water extraction apparatus 146 collect the water and move the water to a gathering location or discharge point where it is removed from the intercooler 30. According to this alternate embodiment multiple water extraction apparatuses 146 may be located between the heat exchanger 40 and the rear wall 38. Additionally, a combination of the embodiment of FIGS. 12 and 14 may be utilized with one or more water extraction apparatuses 146, located immediately after the heat exchanger 40 and additionally extraction devices are located along the rear wall 38.

Technical effects of the embodiments described above include a reduced or eliminated footprint of a working fluid system coupled to an intercooler. A liquefaction fluid of a liquefaction system, such as an LNG system, may be utilized directly or indirectly with the intercooler to cool the compressed gas of the gas turbine system. The relatively low temperature of the liquefaction fluid utilized may enable the utilization of a smaller heat exchanger of the working fluid system. Direct use of the liquefaction fluid with the intercooler may eliminate the complexity, cost, and footprint associated with the working fluid system.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system comprising:
a gas turbine system comprising:
a first compressor stage configured to compress an air flow to a first pressure;
a second compressor stage configured to compress the air flow to a second pressure greater than the first pressure; and
a turbine disposed along an axis of the gas turbine system;
an intercooler heat exchanger disposed between the first compressor stage and the second compressor stage, wherein the intercooler comprises:
a body comprising a plurality of channels configured to receive a cooling fluid; and
a plurality of fins extending from the body, wherein the air flow is configured to flow over the plurality of fins, and the intercooler heat exchanger is configured to transfer heat from the air flow to the cooling fluid; and
a liquefaction system indirectly coupled to the intercooler heat exchanger, wherein the liquefaction system comprises a liquefaction fluid, and the liquefaction fluid is configured to receive heat from the cooling fluid.

2. The system of claim 1, comprising a working fluid system coupled to the intercooler heat exchanger and to the liquefaction system, wherein the working fluid system comprises a working fluid heat exchanger and a pumping system, the pumping system is configured to circulate the cooling fluid from the intercooler heat exchanger to the working fluid heat exchanger, and the working fluid heat exchanger receives the liquefaction fluid from the liquefaction system.

3. The system of claim 2, wherein the liquefaction fluid received by the working fluid heat exchanger is less than 0° C.

4. The system of claim 1, wherein the cooling fluid comprises oil, water, an ethylene glycol solution, or some combination thereof.

5. The system of claim 1, wherein the liquefaction system comprises an air separation system.

6. The system of claim 1, wherein the liquefaction system comprises a liquefied natural gas system configured to receive a gaseous material and to produce a liquefied natural gas product from the gaseous material.

7. The system of claim 6, wherein the liquefaction fluid comprises the liquefied natural gas product.

8. The system of claim 1, wherein the liquefied natural gas system is configured to process the gaseous material to produce the liquefied natural gas product via an AP-C3MR™ process, a cascade process, an AP-X® process, a DMR process, an SMR process, an MFC® process, a PRICO® process, or an AP-N™ process, or any combination thereof.

9. The system of claim 1, wherein the liquefaction fluid comprises a pre-cooling fluid of the liquefaction system, a refrigerant of the liquefaction system, or any combination thereof.

10. The system of claim 1, wherein the intercooler heat exchanger is disposed along the axis of the gas turbine system.

11. The system of claim 1, wherein the plurality of fins of the intercooler heat exchanger comprises skived fins.

12. The system of claim 1, wherein the liquefaction fluid directed to the heat exchanger

13. A system comprising:
a gas turbine system comprising:
a first compressor stage configured to compress an air flow to a first pressure;
a second compressor stage configured to compress the air flow to a second pressure greater than the first pressure; and
a turbine disposed along an axis of the gas turbine system;
an intercooler heat exchanger disposed between the first compressor stage and the second compressor stage, wherein the intercooler comprises:
a body comprising a plurality of channels configured to receive a liquefaction fluid; and
a plurality of fins extending from the body, wherein the air flow is configured to flow over the plurality of fins, and the intercooler heat exchanger is configured to transfer heat from the air flow to the liquefaction fluid; and
a liquefaction system directly coupled to the intercooler heat exchanger, wherein the liquefaction system comprises the liquefaction fluid, and the liquefaction fluid comprises a pre-cooling fluid, a refrigerant, or a liquefied product of the liquefaction system, or any combination thereof.

14. The system of claim 13, wherein the liquefaction system comprises an air separation system.

15. The system of claim 13, wherein the liquefaction system comprises a liquefied natural gas system configured to receive a gaseous material and to produce a liquefied natural gas product from the gaseous material.

16. The system of claim 13, wherein the intercooler heat exchanger is disposed along the axis of the gas turbine system.

17. The system of claim 13, wherein the plurality of fins of the intercooler heat exchanger comprises skived fins.

18. A method comprising:
compressing an air flow to a first pressure;
transferring heat from the air flow to a liquefaction fluid via an intercooler heat exchanger;
compressing the air flow to a second pressure greater than the first pressure;
combusting the air flow and a fuel to generate a combustion product flow; and
driving a turbine with the combustion product flow, wherein the turbine is configured to drive machinery of a liquefaction system, and the liquefaction fluid comprises at least one of a pre-cooling fluid, a refrigerant, and a liquefied product of the liquefaction system.

19. The method of claim 18, wherein transferring heat from the air flow to the liquefaction fluid via the intercooler heat exchanger comprises:
directing a working fluid to the intercooler heat exchanger, wherein the air flow is configured to transfer heat to the working fluid within the intercooler heat exchanger; and
directing the liquefaction fluid to a working fluid heat exchanger, wherein the working fluid is configured to transfer heat to the liquefaction fluid within the working fluid heat exchanger.

20. The method of claim 18, wherein a first stage configured to compress the air flow to the first pressure, a second stage configured to compress the air flow to the second pressure, the turbine, and the intercooler heat exchanger are disposed along a turbine axis.
